(19) United States
(12) Patent Application Publication
(10) Pub. No.: US 2009/0196033 A1
(43) Pub. Date: Aug. 6, 2009

(54) IR/VLS ILLUMINATION SYSTEM

(76) Inventor: Andrew Steven MACDONALD, Culpeper, VA (US)

Correspondence Address: KEATING & BENNETT, LLP, 1800 Alexander Bell Drive, SUITE 200, Reston, VA, 20191, US

(21) Appl. No.: 12/364,689

(22) Filed: Feb. 3, 2009

Related U.S. Application Data
(60) Provisional application No. 61/026,216, filed on Feb. 5, 2008.

(51) Int. Cl. F21V 23/04; F21V 15/01; F21V 33/00; F21K 7/00

(52) U.S. Cl. 362/234; 362/249.01; 362/249.02; 362/249.05

(57) ABSTRACT

An illumination system includes a housing, at least one first light source, and at least one second light source. The at least one first light source emits visible light. The at least one second light source emits IR light. The at least one first light source and the at least one second light source are arranged to emit steady and intermittent light.

### BACKGROUND OF THE INVENTION

1. Field of the Invention

The present invention relates to illumination devices. More specifically, the present invention relates to Infra-red (“IR”) and Visible Light Spectrum (“VLS”) Light Emitting Diode (“LED”) illumination devices.

2. Description of the Related Art

Law enforcement activities are inherently dangerous, with an average of 140 sworn officers killed, and thousands injured every year in the United States alone. Statistically, the majority of officers killed or injured are by themselves and conducting enforcement activities between midnight and 2 AM, when the person or mechanism of injury is encountered.

At times, circumstances dictate individual action on the part of a public safety professional as a matter of duty and obligation to protect life, limb, or property. When these circumstances involve a lone officer actively engaged with a combative subject or facing imminent threat, locating the involved officer is frequently hindered by his or her inability to effectively communicate via radio or by other communication device. In these situations, extended use of communication devices or equipment is, at best, impractical and, at worst, hazardous. This is reflected in the advent and incorporation of the “Emergency Button” on industry standard portable and mobile communication equipment, which effectively sends a distress signal, but does identify the equipment's, and thus the officer's, exact location.

At other times, coordinated multi-officer efforts are put in place to, among other things, preserve crime scenes, control large crowds, or establish perimeters in an attempt to contain and apprehend at-large suspects. In these situations, inter-officer communication and ad-hoc changes to deployment typically necessitate extended verbal, physical, or radio communications between officers, incident commanders, dispatchers, helicopter crew, and other personnel. It is commonplace to relay location and other information by way of physical, audible, or radio communications, e.g. speaking, shouting, and signaling, to line-of-sight personnel with a flashlight or by other overt methods to determine asset location because of the limitations of current equipment.

For public safety first responders and incident commanders, the ability to make rapid and educated decisions during dynamically unfolding incidents has a direct impact on operational integrity, the safety of personnel, and protection of the public. Real-time situational awareness is critical to this task, especially when a lone police officer is faced with an imminent threat and in need of immediate assistance.

The scenarios discussed above exemplify two conflicting, but equally important, requirements for public safety professionals to at different times:
1) deploy and move covertly while maintaining asset identification and communication; and
2) be as conspicuous as possible to other law enforcement officers and the general public when the use of flashlight, verbal, physical, or radio communication is impractical or impossible.
   At present there is no single source solution to address these two competing and oftentimes contemporaneous needs.

Numerous technologies have been designed or adapted for use by law enforcement in an effort to increase efficiency, visibility, and safety during periods of darkness. Examples include but are not limited to: conventional flashlights, spotlights, reflective traffic vests, aerial platform forward looking infrared (FLIR), handheld FLIR, and night vision (NV) technologies. Despite these and other developments, however, statistical evidence clearly shows that darkness is an unavoidable and hazardous condition that continues to pose a substantial threat to public safety personnel.

Unaided vision and the above technologies assist, as operational needs dictate, in detecting heat sources, providing personal illumination, and heightening visibility. Existing technology falls short however, as efficient Friend or Foe (FOF) determination continues to exist only theoretically and is encumbered by unrecognizable, unidentified, and misidentified visual and heat signatures. It is oftentimes impossible to determine if the acquired target is environmental, animal, or human, without extended investigation and communication between ground units and air units, which compromises both operational integrity and the safety of personnel. At present, there exists no technology to efficiently distinguish “who's who,” in a sea of potential public safety personnel, innocent bystanders, and at-large criminal suspects.

Current personal IR technologies applicable to the law enforcement function exist in the form of adhesive IR tape, IR strobes, “personal” wrist mounted infrared beacons, chemical infrared glow sticks (also known as “Chem-lights”), battery powered infrared glow sticks, and IR flashlight filters. VLS LED technologies also exist in the form of personal flashlights and other similar items. All of these existing technologies necessitate the wearing or carrying of additional equipment and separate and distinct devices to employ both IR and VLS functionality. Many of these devices are impractical for wear during routine patrol duties, are prone to mechanical failure, are cumbersome and limiting to range of motion, and are easily transformed into a weapon of opportunity. Furthermore, many existing technologies either require complex and time consuming actions to wear, retrieve, activate, deactivate, and stow or do not provide “hands-free” operation without compromising their safety and effectiveness.

In addition to critical incidents, there are also occasions when suspects flee from police authority or when violators refuse to stop when given a signal or command to do so.

Statistically, vehicle pursuit related crashes most often occur at high speed and during the hours of darkness. Annually, vehicle pursuits are directly related to an average of 50,000 injuries and 341 fatalities per year, with 121 deaths of non-involved parties. In addition to pursuit related injuries and deaths, an average of 13-16 officers are killed per year by being struck by vehicles while on foot.

Policy, technology, and methodology have evolved in an attempt make pursuit efforts safer and more effective. These include, but are not limited to, spike strips, Stop Sticks, and the Precision Immobilization Technique. Notably, these options all constitute a use of force, carry with them varying levels of risk to involved parties and the general public, and involve extraordinary measures that at a minimum result in property damage to the suspect vehicle. Moreover, these options are all geared towards ending a pursuit after it has begun. Intuitively, if an apparatus could eliminate or reduce the need for pursuit to begin with, a heightened level of safety would be enjoyed.

### SUMMARY OF THE INVENTION

In order to overcome the problems described above, preferred embodiments of the present invention provide a dual spectrum illumination system capable of emitting light in both the infra-red and visible light spectra from a single source/apparatus. Preferred embodiments of the present invention integrate with existing technology, equipment, and law enforcement best practices providing a system practical for wear and deployment during routine patrol and enforcement duties. Preferred embodiments of the present invention do not compromise, but rather promote operational integrity and personal safety, and increase situational awareness and efficiency of mission critical public safety operations. Preferred embodiments are readily deployed on one's person, on a vehicle, or any object or location and are capable of being rapidly converted, as operational needs dictate, from an invisible covert locating device (IR) to highly conspicuous visible light (VLS) beacon for personal, resource, object, and environmental illumination.

According to a preferred embodiment of the present invention, the illumination system is contained in a small, portable housing including both IR and VLS LED arrays in electrical communication with a controller and power source and including structures for activating the LED arrays. The LED arrays include one or more individual light-emitting diodes arranged in a linear or a circular fashion.

According to a preferred embodiment of the present invention, the IR/VLS system incorporates a structure, magnet, or other mechanism to affix the IR/VLS system to clothing or a designated object, which provides for operation in a “hands-free” condition.

According to a preferred embodiment of the present invention, the IR/VLS system emits, at the preference of an individual, infrared and visible light independently or simultaneously and in steady or intermittent fashion.

According to a preferred embodiment of the present invention, the VLS array is highly visible at night and during daylight hours from considerable distances, increasing personal visibility whenever operational needs require close proximity to vehicular traffic or rapid location by other individuals.

According to a preferred embodiment of the present invention, the IR array is clearly detected by Night Vision (NV), Forward Looking Infrared (FLIR), and other industry standard optics from considerable distances, allowing for heightened situational awareness via aerial and ground surveillance during deployment and pursuit situations.

According to a preferred embodiment of the present invention, an illumination system includes a housing, at least one first light source, and at least one second light source. The at least one first light source emits visible light. The at least one second light source emits IR light. The at least one first light source and the at least one second light source are arranged to emit steady and intermittent light.

The at least one first light source and the at least one second source are preferably LEDs. The illumination system preferably further includes at least one processing unit connected to the at least one first light source and the at least one second source. The illumination system preferably further includes a first switch connected to the at least one first light source and a second switch connected to the at least one second light source.

The first switch and the second switch are preferably arranged to independently control the at least one first light source and the at least one second light source such that the at least one first light source and the at least one second light source separately or simultaneously emit light. The illumination system preferably further includes a power source connected to the at least one first light source and the at least one second light source. The at least one first light source and the at least one second light source are preferably disposed on the housing for optimum visibility. The illumination system preferably further includes a speaker and a microphone. The illumination system preferably further includes a magnet arranged to allow the illumination system to be attached to a metal object.

The illumination system preferably further includes a switch with a ferrous metal sensor, where the switch activates the at least one first light source, the at least one second light source, or both the at least one first light source and the at least one second light source when ferrous metal is detected by the ferrous metal sensor. The illumination system preferably further includes a mechanical attachment that is arranged to attach the illumination system to a person, an objects, or a location.

According to another preferred embodiment of the present invention, the illumination system is preferably activated in a directional fashion and is preferably capable of being employed as a distraction device or “flashlight.”

According to another preferred embodiment of the present invention, the illumination system is preferably capable of being deployed on one's person, on a vehicle, on a service/K9 dog, or any other desired location or object, magnetically or mechanically, thereby covertly or overtly designating said location or object at the preference of an individual.

According to another preferred embodiment, the illumination system preferably increases the visibility, detection, location, and monitoring of a vehicle or object on which is it deployed, without using force or causing property damage.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is an operational overview of an IR/VLS illumination system according to a preferred embodiment of the present invention.

FIGS. 2A-2F are various views of the IR/VLS illumination system shown in FIG. 1 that includes a remote speaker microphone housing.

FIG. 3 is a detailed front view of the IR/VLS illumination system shown in FIG. 2.

FIGS. 4A and 4B are left and right views, respectively, of the IR/VLS illumination system shown in FIG. 2.

FIG. 5 is a rear view of the IR/VLS illumination system shown in FIG. 2.

FIGS. 6A and 6B are top and bottom views, respectively, of the IR/VLS illumination system shown in FIG. 2.

FIGS. 7A and 7B are front and rear isometric views, respectively, of the IR/VLS illumination system shown in FIG. 2.

FIG. 8 is rear sectional view of the IR/VLS illumination system shown in FIG. 2.

FIG. 9 is an operational overview of an IR/VLS illumination system according to a preferred embodiment of the present invention.

FIGS. 10A-10D are various views of a IR/VLS illumination system shown in FIG. 9.

FIG. 11 is a top view of the IR/VLS illumination system shown in FIG. 10.

FIG. 12 is a bottom view of the IR/VLS illumination system shown in FIG. 10.

FIGS. 13A and 13B are detailed side views of the IR/VLS illumination system shown in FIG. 10.

FIGS. 14A and 14B are top and bottom isometric views of the IR/VLS illumination system shown in FIG. 10.

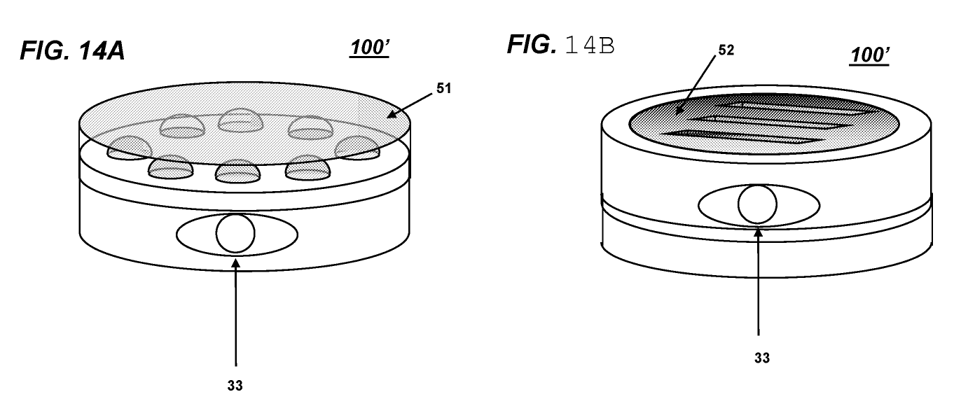

FIG. 15 is s sectional view of the IR/VLS illumination system shown in FIG. 10.

FIG. 16 is an environmental view of the IR/VLS illumination system shown in FIG. 10 that is magnetically attached to an object.

FIG. 17 is an environmental view of the IR/VLS illumination system shown in FIG. 10 that mechanically attached to an object.

FIGS. 18A-18D are schematics representation of processing units including 1.5 V LED Flash Modules/ICs according to a preferred embodiment of the present invention.

FIG. 19 is a circuit diagram of a processing unit including a 3V LED Flash module/ICs according to a preferred embodiment of the present invention.

FIG. 20 is a circuit diagram of an LED array including a single LED chip that does not include a processing unit or discreet electronics according to a preferred embodiment of the present invention.

FIG. 21 is a circuit diagram of a processing unit including 9 V LED flash modules having ferrous metal detection for circuit activation.

### DETAILED DESCRIPTION OF PREFERRED EMBODIMENTS

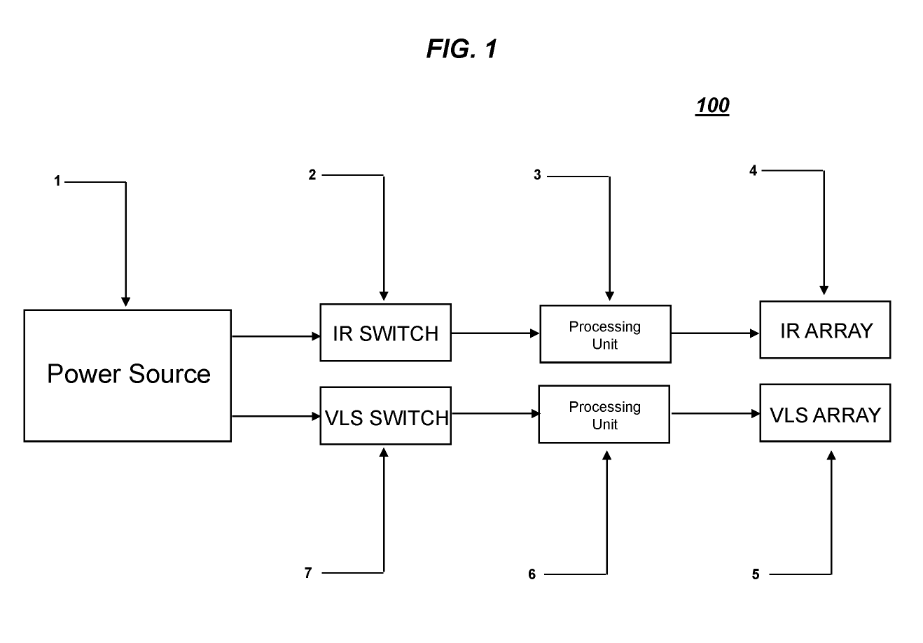

An IR/VLS illumination system 100 according to a preferred embodiment of the present invention is shown in FIG. 1. Activation switches 2 and 7 provide power to the IR 3 and VLS 6 processing units, respectively. When the activation switches 2, 7 are in the “on” position, the IR 3 and VLS 6 processing units distribute power to the IR 4 and VLS 5 LED arrays. The IR 4 and VLS 5 LED arrays are preferably independently controlled, at the preference of the operator, to provide steady or intermittent illumination so that VLS only, IR only, or VLS and IR simultaneously illumination is provided. IR LED array 4 includes one or more IR LEDs that are preferably connected in parallel. However, the IR LEDs can be connected in any suitable manner. The IR LEDs are LEDs that mostly, if not completely, emit IR light. Similarly, VLS LED array 5 includes one or more VLS LEDs that are preferably connected in parallel. However, the VLS LEDs can be connected in any suitable manner. The VLS LEDs are LEDs that mostly, if not completely, emit visible light.

The power source 1 is preferably capable of delivering about 1.5 V to about 9 V. However, it is also possible that the power source delivers different voltages, as circuit design dictates. While power source 1 is preferably a battery, it is also possible to use any other suitable power supply, e.g. high capacity capacitors. It is also possible that at least a portion of the power supply is external to the housing 10. For example, the IR/VLS illumination system 100 can be stored in a vehicle where the IR/VLS illumination system 100 can be charged or can be powered by the vehicle's battery.

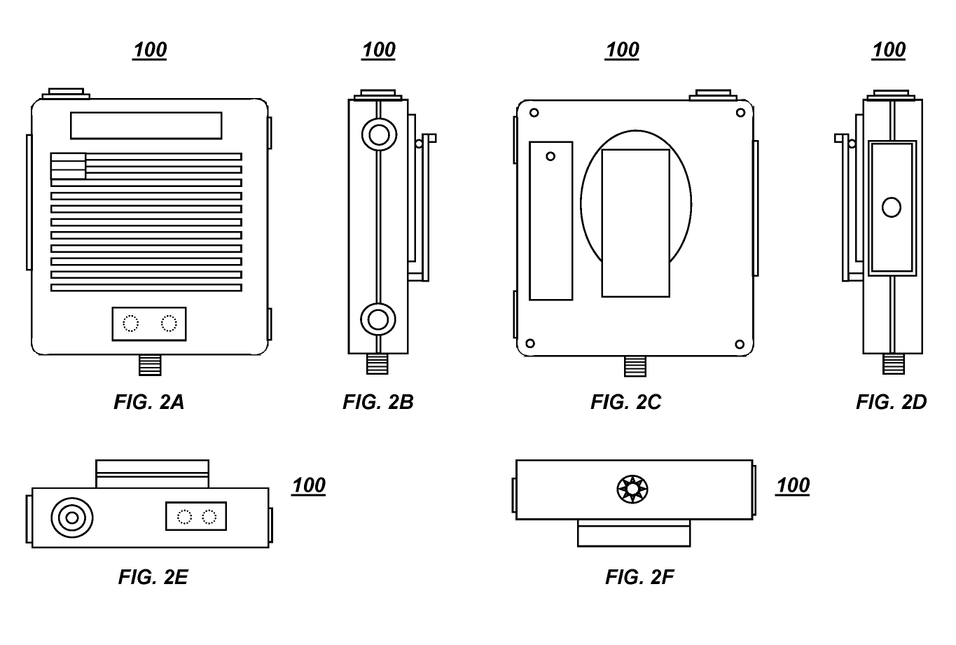

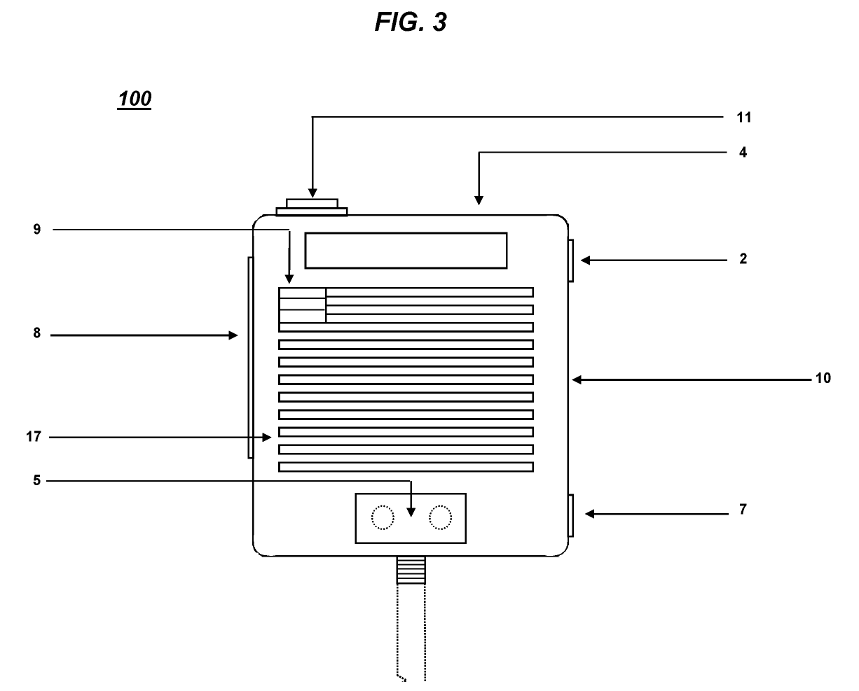

Various views of the IR/VLS illumination system 100 are shown in FIGS. 2A-2F. Referring to FIG. 3, the IR/VLS illumination system 100 includes a housing 10, IR LED array 4, IR array activation switch 2, VLS array 5, and VLS array activation switch 7. As shown in FIG. 3, the IR/VLS illumination system 100 is preferably incorporated into an industry standard Remote Speaker Microphone including antenna jack 11, audio speaker 17, audio microphone 9, and push-to-talk switch 8. However, it is also possible to use to IR/VLS illumination system 100 as a stand-alone device, or to incorporate it into other common and pre-existing public safety devices, including but not limited to expandable batons, pistol grips, and belt-keepers.

VLS LED array 5 includes one or more individual VLS LEDs that are preferably positioned for maximum visibility on the front of the housing 10. However, it is also possible to position VLS LEDs at other locations, e.g. top, of the housing 10 or to position VLS LEDs at multiple locations, e.g. front and top, of the housing 10.

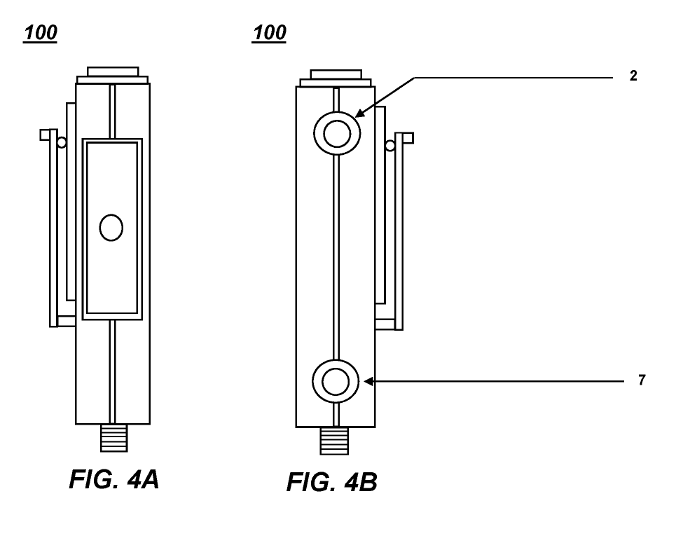

Referring to FIG. 4, IR 2 and VLS 7 array activation switches are preferably recessed and positioned to facilitate differentiation and use during inclement weather, while wearing gloves or personal protective equipment (PPE), or when imminent threat requires rapid activation and return to hands-free condition.

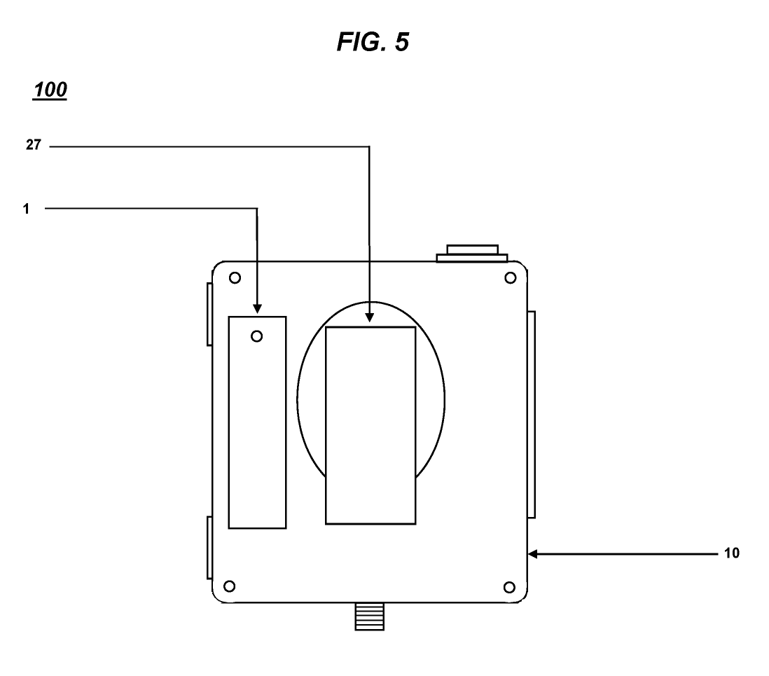

Referring to FIG. 5, housing 10 preferably includes a power source 1 and a clothing clip 27. Instead of clothing clip 27, it is also possible to use any suitable structure for attachment to a person's clothing. In this preferred embodiment, clothing clip 27 allows the user to avoid the time-consuming process of retrieving, activating, deactivating, and stowing a flashlight or other individual VSL or IR device. Notably, power source 1 can be contained within housing 10 or can be shared with another electronic device.

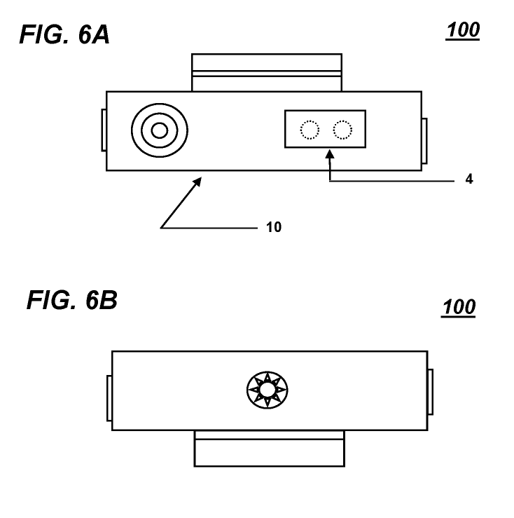

Referring to FIGS. 6A-6B, IR LED array 4 includes one or more individual IR spectrum LEDs that are preferably positioned for maximum visibility on the top of the housing 10. However, it is also possible to position IR LEDs at other locations, e.g. front, of the housing 10 or to position VLS LEDs at multiple locations, e.g. front and top, of the housing 10. It is also possible to position the VLS LEDs and IR LEDs on the same surface of the housing 10.

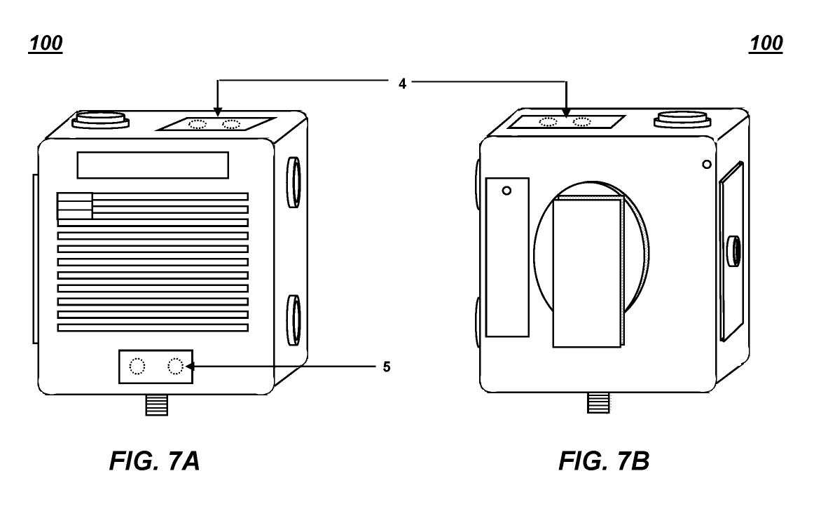

As seen in FIGS. 7A-7B, the VLS LED array 5 projects high-intensity, highly-visible VLS illumination forward of the IR/VLS illumination system 100, while IR LED array 4 projects IR illumination from the top of the IR/VLS illumination system 100. This arrangement allows for rapid detection with the naked eye and with industry standard FLIR, IR, and NV technologies as operational needs dictate.

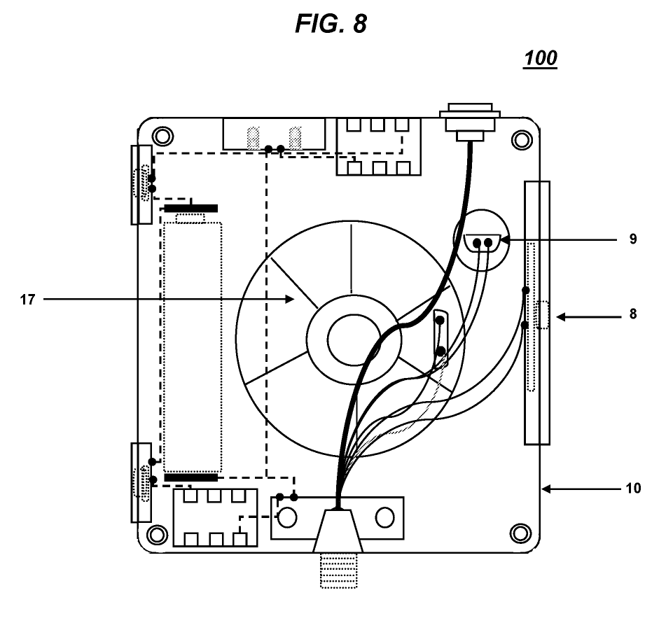

A specific example of the arrangement of the internal components of IR/VLS illumination system 100 that included microphone 9 and housing 10 is shown in FIG. 8. The circuit path of the IR/VLS illumination system 100 is shown in dashed lines, and the circuit path of the audio speaker 17, audio microphone 9, and push-to-talk switch 8, is shown in solid lines. Other suitable arrangements of the internal components of the IR/VLS illumination system 100 can also be used.

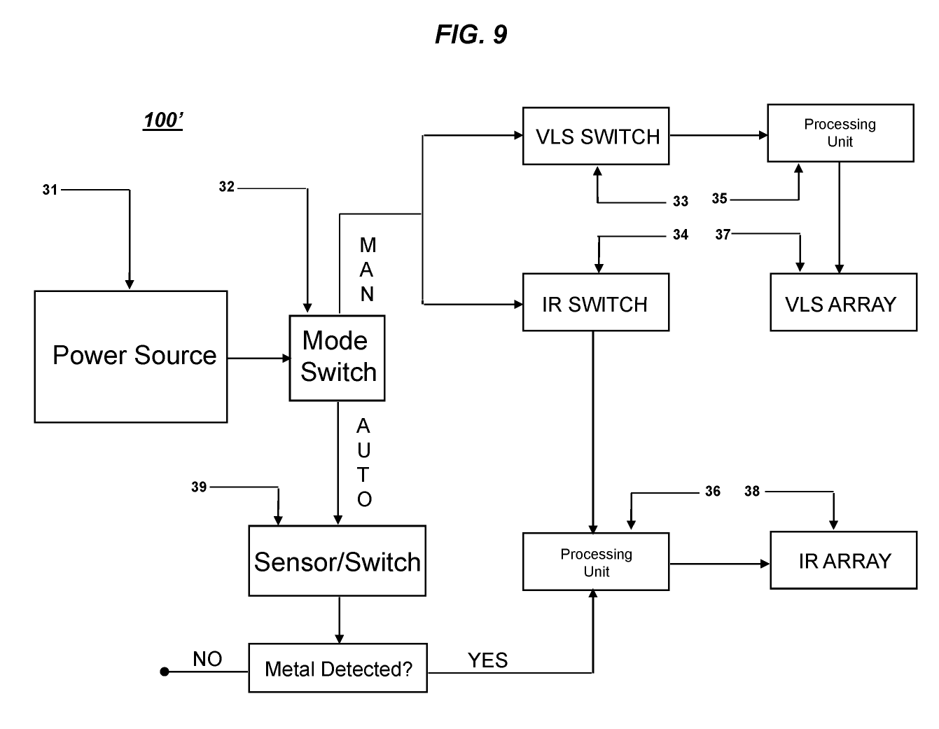

An IR/VLS illumination system 100′ according to a preferred embodiment of the present invention is shown in FIG. 9. The IR/VLS illumination system 100′ includes two activation modes (automatic and manual) that can be selected at the preference of an individual.

Mode switch 32 is connected in series forward of the power source 31. When in “manual mode,” or position 1, power flows to VLS array activation switch 33 and IR array activation switch 34. While in “manual mode,” VLS array activation switch 33 and IR array activation switch 34 determine power distribution to the VLS 35 and IR 36 processing units, respectively. When VLS 33 and IR 34 array activation switches are in the “on” position, the VLS 35 and IR 36 processing units determine power distribution to the VLS 37 and IR 38 LED arrays. The VLS 37 and IR 38 LED arrays are preferably independently controlled, at the preference of the operator, to provide steady or intermittent illumination so that VLS only, IR only, or VLS and IR simultaneously illumination is provided. IR LED array 38 includes one or more IR LEDs that are preferably connected in parallel. However, the IR LEDs can be connected in any suitable manner. Similarly, VLS LED array 37 includes one or more visible spectrum LEDs that are preferably connected in parallel. However, the VLS LEDs can be connected in any suitable manner. IR 38 and VLS 37 LED arrays are arranged to be in electric communication with the IR 36 and VLS 35 processing units, the IR 34 and VLS 33 array activation switches, and the shared power source 31. When activated, IR LED array 38 will produce IR illumination. Similarly, when activated, VLS LED array 37 will produce high-intensity visible illumination.

When mode switch 32 is in “automatic mode,” or position 2, power is not distributed to the VLS 33 and IR 34 array activation switches, but alternately to sensor/switch 39. Sensor/switch 39 is designed to allow power to flow to the IR processing unit 36, activating IR LED array 38 as described above, when placed in close proximity to ferrous metal. The VLS LED array 37 is preferably not functional while automatic mode. However, it is also possible to activate VLS LED array 37 while in automatic mode.

The power source 31 preferably is capable of delivering about 1.5 V to about 9 V as circuit design dictates and can be independent or shared with another electronic device. However, it is also possible that the power source 31 delivers different voltages, as circuit design dictates. While power source 31 is preferably a battery, it is also possible to use any other suitable power supply.

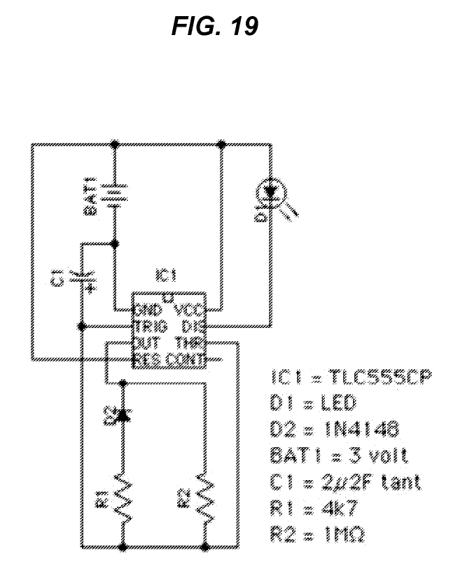

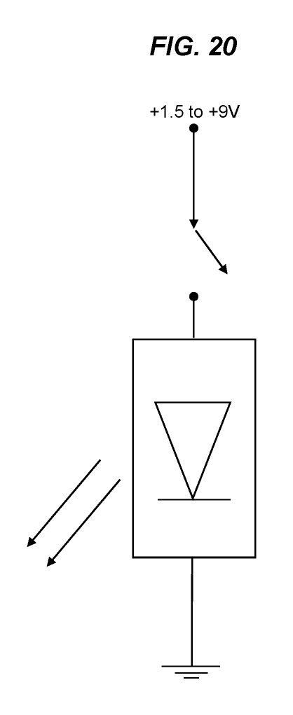

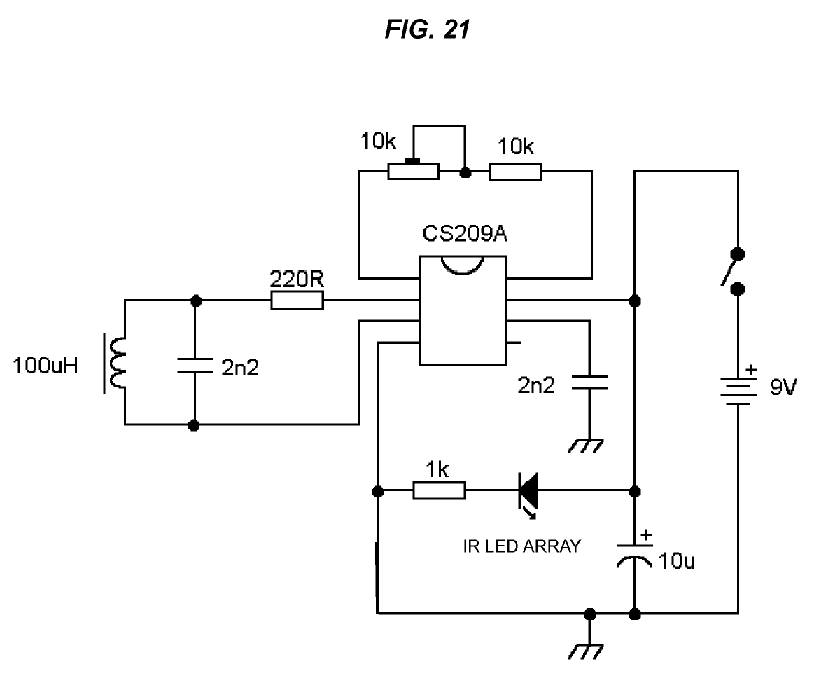

Specific examples of the VLS 35 and IR 36 processing units are shown in further detail in FIGS. 19 and 20. Other suitable arrangements of the VLS 35 and IR 36 processing units of the IR/VLS illumination system 100′ can also be used. A specific example of the sensor/switch 39 is shown in FIG. 21. The sensor/switch 39 includes a single 100 μH choke capacitor as a metal detector. The CS209A IC has an integral oscillator whose inductance is altered by the proximity of ferrous material. The change in the oscillation is amplified and demodulated. Referring again to FIG. 9, when mode switch 32 is in “Automatic” mode or position 2, the LED array will activate when the apparatus is placed in close proximity to ferrous metal as the inductance of the choke changes, which allows power to flow to IR processing unit 36. Other suitable arrangements of the sensor/switch 39 of the IR/VLS illumination system 100′ can also be used. For example, the ferrous metal sensor could be replaced or used in combination with a remote activation sensor or any other suitable conditional activation structure so that the IR/VLS illumination system 100′ can be activated by a remote user. For example, it is possible for the IR LED array 38 to be activated when the ferrous metal sensor senses ferrous metal and for the VLS LED array 37 to be activated by a remote activation sensor.

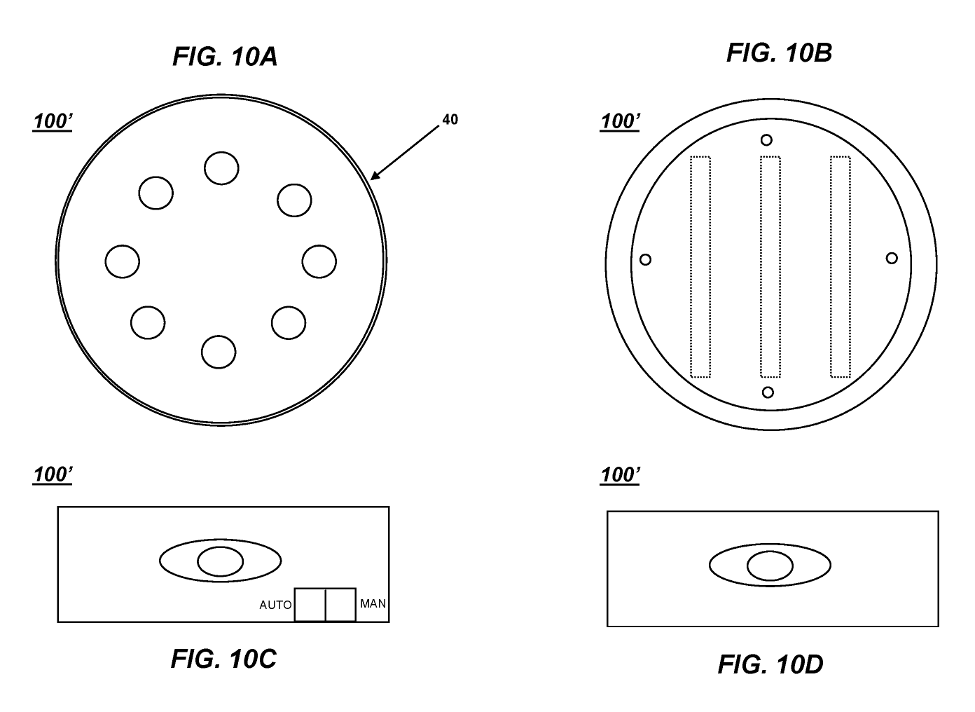

FIGS. 10A-10D shows various views of the IR/VLS illumination system 100′ that includes a small circular housing 40 capable of rapid transport to and magnetic or mechanical deployment on a plurality of surfaces or locations.

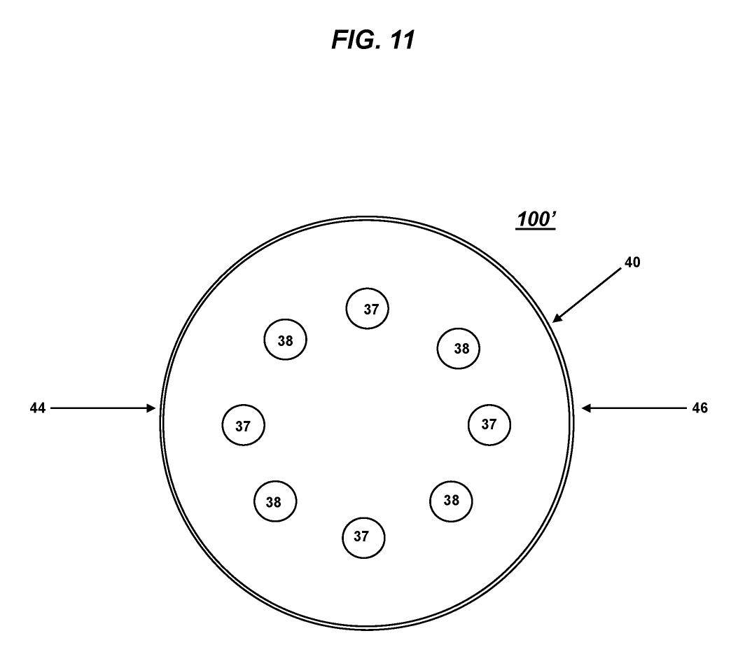

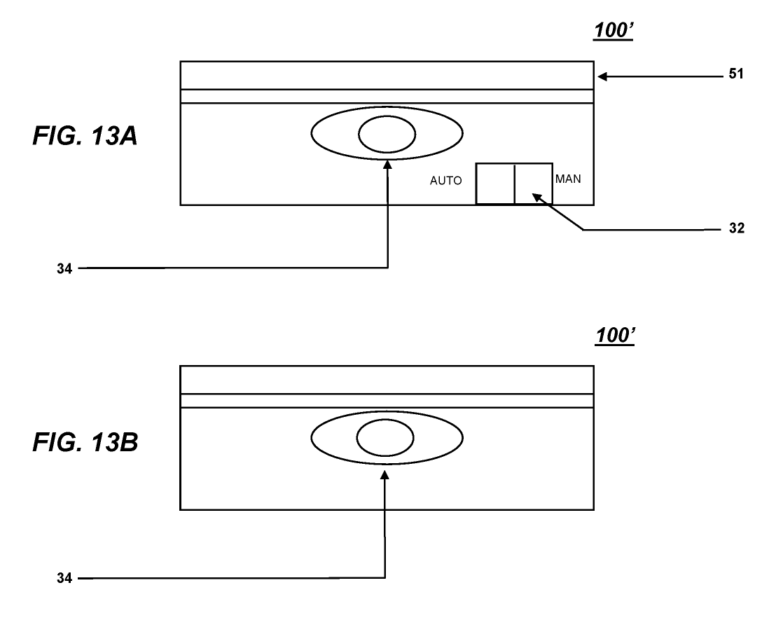

Referring to FIG. 11, the IR/VLS illumination system 100′ includes an independent, standalone housing 40, preferably made rubber or plastic but any other suitable can also be used. The IR/VLS illumination system 100′ includes VLS 37 and IR 38 LED arrays preferably disposed in a circular or linear fashion. VLS 44 and IR 46 array activation buttons are positioned for easy differentiation and activation. Referring to FIG. 13, transparent cover 51 allows for IR/VLS illumination projection.

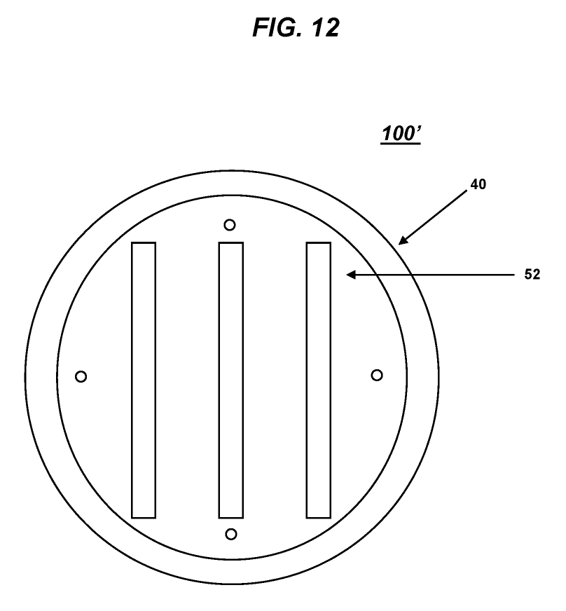

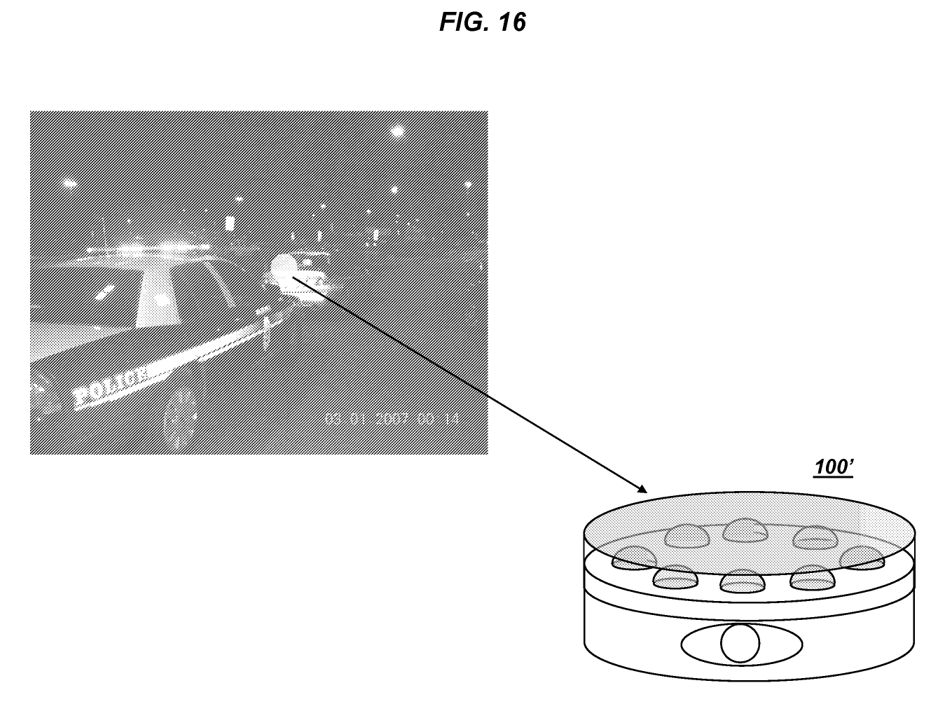

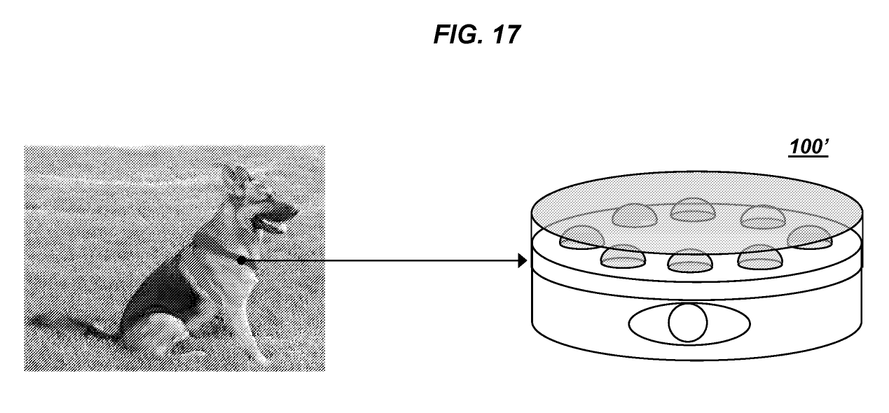

Referring to FIG. 12, the IR/VLS illumination system 100′ preferably provides for magnetic attachment or mechanical attachment to a person, a belt, a service dog/k9 or other object. Magnetic attachment is provided by a magnet included in the floor plate 52. It is possible to use any suitable magnetic material for the magnet. Mechanical attachment is provided by recessed inlets allowing for the apparatus to be threaded through a belt, epaulet, service dog harness, lead, other anchoring devices, or other suitable structure. For example, the IR/VLS illumination system 100′ can be temporarily affixed to any object using a buckle, suction cups, clips, hook and loop fabric material such as Velcro™, and/or any other temporary, releasable mechanism. This allows the IR/VLS illumination system 100′ to be utilized in a variety of applications and deployed on a multitude of surfaces, for example on a vehicle or service dog harness as shown in FIGS. 16 and 17, to surreptitiously or overtly designate any stationary suspect, target, undercover vehicles, or other desired objects and locations for ground and aerial surveillance.

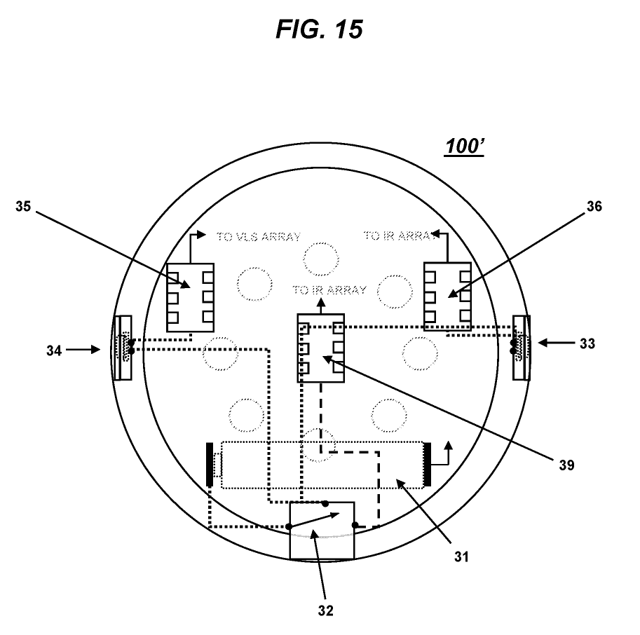

Upon activation, the IR/VLS illumination system 100′ will preferably flash a user defined IR, VLS, or combination IR/VLS sequence, allowing for detection with NV or FLIR optical aids or the naked eye (VLS only) as operational needs dictate, thereby facilitating the location, detection, and monitoring of the vehicle, object, or location on which it is deployed. When in ‘automatic’ mode, the IR/VLS illumination system 100′ will preferably automatically activate the IR LED array 38 when placed on a vehicle, such as during routine traffic stops or investigations involving vehicles. The same functionality can also be used in ‘manual’ mode, which also allows for rapid and non-permanent demarcation of evidence or points of interest. A specific example of the arrangement of the internal components of IR/VLS illumination system 100′ is shown in FIG. 15. Other suitable arrangements of the internal components of the IR/VLS illumination system 100′ can also be used.

Both IR/VLS illumination system 100 and 100′ can be used in a variety of public safety, civilian, and private sector applications, including but not limited to police operations, fire and rescue operations, road-construction operations, civilian GMRS radios, and hunting with dogs in municipalities which allow such activities after dusk.

Activation switches 2, 7, 33, 34 are preferably of the push button variety, where the depression of the switch results in an “on” condition and allows power to flow though the circuit. However, other suitable switches of any mechanical or electronic design allowing for manual or remote activation can be used. Processing units 3, 6, 35, 36 are preferably timer circuits. However, other suitable circuit designs and discreet electronic components can be used in combination. For example, timer circuits can be replaced with custom programmed CMOS or similar devices. Alternately, the use of single chip flashing LED's shown in FIG. 20 with built in modules can eliminate the need for processing units completely.

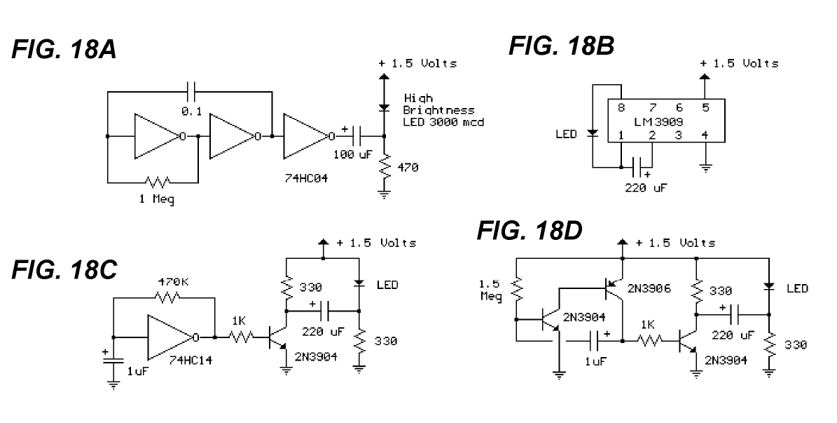

FIG. 18A shows a specific example of circuit according to a preferred embodiment of the present invention. The circuit uses a 100 μF capacitor to double the battery voltage of a single 1.5 V power source to obtain 3 V for the LED arrays. Two sections of a 74HC04 hex inverter are used as a square-wave oscillator that establishes the flash rate, while a third section is used as a buffer that charges the capacitor in series with a 470Ω resistor, while the buffer output is at +1.5 V. When the buffer output switches to ground (zero volts) the charged capacitor is placed in series with the LEDs and the battery that supplies enough voltage to illuminate the LEDs. The LED current is approximately 3 mA, capable of achieving the desired high intensity illumination.

Alternately, FIG. 18B shows another circuit according to a preferred embodiment of the present invention. The circuit uses an LM3909 LED flasher IC and requires only a timing capacitor and LED to achieve the desired illumination. FIGS. 18C and 18D use the voltage doubling principle discussed above, with the addition of a transistor to allow the capacitor to discharge faster and to supply a greater current. A larger capacitor (1000 μF) in series with a 33Ω resistor increases the flash duration to about 50 ms. The discrete three transistor circuit shown in FIG. 18D is capable of adjusting the pulse width via a resistor in series with the 1 μF capacitor. FIG. 19 shows a circuit design that achieves the same or substantially the same effect, but utilizing a 3 V input and a 555 timer IC instead. FIG. 20 shows an example of a single chip LED designed to produce intermittent illumination by, without the use of additional electronic components.

It should further be noted that in each of the preferred embodiments presented, the VLS arrays may be the same or differently colored LED's within the visible light spectrum.

While preferred embodiments of the present invention have been described above, it is to be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An illumination system comprising:
a housing;
at least one first light source; and
at least one second light source; wherein
the at least one first light source emits visible light;
the at least one second light source emits IR light; and
the at least one first light source and the at least one second light source are arranged to emit steady and intermittent light.

2. An illumination system according to claim 1, wherein the at least one first light source and the at least one second source are LEDs.

3. An illumination system according to claim 1, further comprising at least one processing unit connected to the at least one first light source and the at least one second source.

4. An illumination system according to claim 1, further comprising:
a first switch connected to the at least one first light source; and
a second switch connected to the at least one second light source.

5. An illumination system according to claim 4, wherein the first switch and the second switch are arranged to independently control the at least one first light source and the at least one second light source such that the at least one first light source and the at least one second light source separately or simultaneously emit light.

6. An illumination system according to claim 1, further comprising a power source connected to the at least one first light source and the at least one second light source.

7. An illumination system according to claim 1, wherein the at least one first light source and the at least one second light source are disposed on the housing for optimum visibility.

8. An illumination system according to claim 1, further comprising a speaker and a microphone.

9. An illumination system according to claim 1, further comprising a magnet arranged to allow the illumination system to be attached to a metal object.

10. An illumination system according to claim 1, further comprising a switch with a ferrous metal sensor; wherein
the switch activates the at least one first light source, the at least one second light source, or both the at least one first light source and the at least one second light source when ferrous metal is detected by the ferrous metal sensor.

11. An illumination system according to claim 1, further comprising a mechanical attachment that is arranged to attach the illumination system to a person, an objects, or a location.
